(19) United States
(12) Patent Application Publication
(10) Pub. No.: US 2004/0227332 A1
(43) Pub. Date: Nov. 18, 2004

(54) Assembly

(75) Inventor: Ralf Scherer, Aschaffenburg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/840,864

(22) Filed: May 7, 2004

(30) Foreign Application Priority Data
May 7, 2003 (DE) 203 07 142.5

(51) Int. Cl. B60R 21/16

(52) U.S. Cl. 280/728.2

(57) ABSTRACT

An assembly for fastening a gas bag module to a vehicle, in particular in a steering wheel, has a first and a second detent element in engagement with each other defining a detent connection in a closed state. The first detent element and the second detent element are movable relative to each other in a movement direction over a defined displacement path. The first detent element has an indentation in which a contact region is formed running obliquely to the movement direction. The second detent element has at least one detent section, which is able to be brought into abutment with the contact region, and the detent section lies against the contact region under prestressing (F) over the entire displacement path.

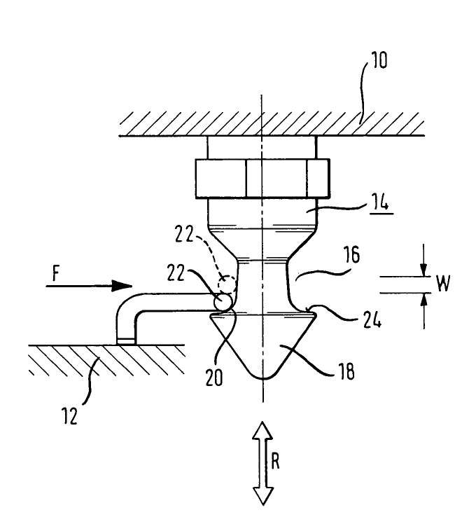

### FIELD OF THE INVENTION

The invention relates to an assembly for fastening a gas bag module to a vehicle, in particular to a steering wheel.

### BACKGROUND OF THE INVENTION

The fixing of the gas bag module in the steering wheel takes place frequently by means of detent connections, which are preferably designed so that the gas bag module is able to be moved into the steering wheel in a movement direction which coincides with the axial direction of the gas bag module or the rotation axis of the steering wheel, in order to actuate a horn. With this movement, the detent elements move relative to each other, without, however, the detent connection being detached. In normal driving operation, i.e. when the horn is not actuated, the gas bag module is generally acted upon by spring elements, which prevent it from a movement in axial direction, for example by vehicle vibrations. However, it is not possible to eliminate every slight relative movement between the two detent elements, so that additional provisions have to be made in order to prevent rattling noises which are induced by such movements. Known solutions comprise the provision of additional damping elements between the detent elements or the application of a plastic coating for noise damping. Both methods mean an additional expenditure and additional costs in the manufacturing process.

### BRIEF SUMMARY OF THE INVENTION

It is an object of the invention to provide an assembly in which rattling noises between the detent elements are avoided in a simple manner.

This is achieved in an assembly for fastening a gas bag module to a vehicle, in particular in a steering wheel, which has a first and a second detent element in engagement with each other defining a detent connection in a closed state. The first detent element and the second detent element are movable relative to each other in a movement direction over a defined displacement path. The first detent element has an indentation in which a contact region is formed running obliquely to the movement direction. The second detent element has at least one detent section, which is able to be brought into abutment with the contact region, and the detent section lies against the contact region under prestressing (F) over the entire displacement path.

Since during a relative movement in the movement direction, the two detent elements never detach themselves from each other, rattling noises can not occur. The constant abutment of the two detent elements against each other is achieved solely through the geometric shape of the indentation or of the contact region and also the setting of the prestressing under which the detent elements lie against each other. Additional damping elements or coatings can be dispensed with entirely.

In a so-called floating horn gas bag module, the displacement path can be the stroke for actuation of a horn. The displacement path, however, can also be selected to be smaller, so that it is only the play which is present after installation between gas bag module and vehicle.

In a preferred embodiment of the invention, the contact region is curved in a concave shape. However, it can also be realized by a slant running linearly or non-linearly. The contact region can run obliquely relative to the movement direction over the entire displacement path.

The detent section can be part of a spring wire. The indentation is preferably provided on a detent hook.

When the indentation runs obliquely immediately after a hook rear side extending perpendicularly to the movement direction, the advantage is produced that the hook rear side can form an end stop for the relative movement of the two detent elements, whereas every relative movement between the detent elements starting from the position defined by the end stop takes place immediately along the contact region.

Such a construction can also be achieved on a detent hook formed as a detent pin.

In an advantageous embodiment, the contact region runs obliquely outwards towards a free, thickened end (e.g. a hook tip) of the first detent element. This allows the invention to be realized under saving of material costs and installation expenditure, for a use in conventional detent connections.

The first detent element is preferably connected with the gas bag module, whereas the second detent element is connected with a steering wheel skeleton. The arrangement of the detent elements on these components can, however, also be reversed.

### BRIEF DESCRIPTION OF THE DRAWING

The single figure shows a diagrammatic view of an assembly according to the invention.

### DETAILED DESCRIPTION OF A PREFERRED EMBODIMENT

The illustrated assembly serves for fastening a gas bag module 10 to a steering wheel skeleton 12. These two components are only indicated diagrammatically, because their precise shape and also the construction of the connection of the detent elements with these components does not play any part in the invention.

On the gas bag module 10, as first detent elements one or more detent hooks are arranged, constructed as detent pins 14, which are respectively provided with an encircling indentation 16. At its thickened, free, lower end, each detent pin 14 has a tapered insertion chamfer 18, which is used in a known manner in the formation of the detent connection.

In the indentation 16 a contact region 20 is formed, which extends obliquely to a movement direction R of the gas bag module 10. The movement direction R coincides with the axial direction of the gas bag module 10 or the rotation axis of the steering wheel and the displacement direction of the gas bag module into the steering wheel for actuation of a horn. It also corresponds to the direction in which the detent connection is closed.

In the example illustrated here, the contact region 20 ends in a lower stop, which is formed by a hook rear side 24 extending perpendicularly to movement direction R, which delimits a movement of the detent pin 14 upwards out from the steering wheel. From the hook rear side 24, the contact region 20 runs with concave curvature towards the gas bag module 10, with the contact region 20 running obliquely outwards to the free, thickened end of the detent pin 14, which carries the insertion chamfer 18.

A detent section 22 of a second detent element, which is constructed here as an elongated spring wire connected securely with the steering wheel skeleton 12 (this is indicated diagrammatically in the figure), lies against the contact region 20 in the closed state of the detent connection which is shown.

The two detent elements 14, 22 are movable in the movement direction R towards each other by a precisely defined displacement path W. This displacement path W can, for example, be a stroke for actuation of a horn (not shown), i.e. can correspond to the distance between two horn contacts. The displacement path W may, however, also be so small that it merely corresponds to a play.

The contact region 20 extends over the entire displacement path W and is curved or oriented obliquely relative to the movement direction R along the whole displacement path W.

The detent section 22 lies constantly under a prestressing F, which acts perpendicularly to the movement direction R towards the detent pin 14, against the contact region 20. This is fulfilled over the entire displacement path W. Therefore, if the first detent element, i.e. the detent pin 14 moves in relation to the detent section 22 in the movement direction R, then at no time is the contact between the detent section 22 and the contact region 20 disconnected. Therefore, a jerky movement of the two detent elements towards each other, which could lead to a rattling noise, never occurs. The prestressing F and also the necessary movement play of the detent section 22 perpendicularly to the movement direction R, which makes it possible for the detent section 22 to move along the contact region 20, and the slant or curvature of the contact region 20, are to be coordinated with each other in accordance with the respective requirements, so that the constant abutment of the detent section 22 against the contact region 20 is guaranteed.

The position of the detent section 22 in abutment against the hook rear side 24 at a first, lower end point of the relative movement of the two detent elements 14, 22 is illustrated by continuous lines in the figure, whereas the position of the detent section 22 at a second, upper end point is illustrated in dotted lines.

The displacement path W could also be realized by means of a contact region, the incline of which is oriented in opposition to the contact region 20 which is shown, as is illustrated in the figure, for example at the upper end of the indentation 16.

The necessary prestressing F can be realized either by the inherent elasticity of the second detent element, by the latter being formed for example from a spring wire, or a separate spring element (not shown) could be provided, which prestresses the detent section 22 of the second detent element in the direction of the contact region 20.

To close the detent connection, the gas bag module 10 is inserted into the steering wheel in movement direction R. Here, the inherent elasticity of the second detent element or the spring element generating the prestressing F permits a sideways movement of the detent section 22 by the insertion chamfer 18, so that the free end of the detent pin 14 can slide past the detent section 22. With the detent connection 14, 22 closed, an elongated part of the spring wire forming the detent section 22 then lies against the obliquely-running contact region 20 formed in the indentation 16 of the detent pin 14.

The principle of the assembly according to the invention can also be transferred to any other detent connection in which corresponding detent elements are provided, which are intended to be movable towards each other by a certain amount.

1. An assembly for fastening a gas bag module (10) to a vehicle, in particular in a steering wheel,
with a first and a second detent element in engagement with each other to define a detent connection in a closed state, said first detent element and said second detent element being movable relative to each other in a movement direction (R) over a defined displacement path (W),
said first detent element having an indentation (16) in which a contact region (20) is formed running obliquely to said movement direction (R) and
said second detent element having at least one detent section (22), which is able to be brought into abutment with said contact region (20) and
said detent section (22) lying against said contact region (20) under prestressing (F) over the entire displacement path (W).

2. The assembly according to claim 1, wherein said contact region (20) is curved in a concave shape.

3. The assembly according to claim 1, wherein said contact region (20) runs obliquely relative to said movement direction (R) over said entire displacement path (W).

4. The assembly according to claim 1, wherein said displacement path (W) is a stroke for actuation of a horn.

5. The assembly according to claim 1, wherein said detent section (22) is part of a spring wire.

6. The assembly according to claim 1, wherein said indention (16) is constructed on a detent hook.

7. The assembly according to claim 6, wherein said indentation (16) runs obliquely immediately after a hook rear side (24) extending perpendicularly to said movement direction (R).

8. The assembly according to claims 6, wherein said detent hook is a detent pin (14).

9. The assembly according to claim 1, wherein said contact region (20) runs obliquely outwards towards a free, thickened end of said first detent element.

10. The assembly according to claim 1, wherein said first detent element is connected with said gas bag module (10) and said second detent element is connected with a steering wheel skeleton (12).
